(19) United States
(12) Patent Application Publication
(10) Pub. No.: US 2017/0034043 A1
(43) Pub. Date: Feb. 2, 2017

(54) PROTECTION METHOD, COMMUNICATION SYSTEM, AND END NODE

(71) Applicant: FUJITSU LIMITED, Kawasaki-shi (JP)

(72) Inventor: Yuji Tochio, Yokohama (JP)

(73) Assignee: FUJITSU LIMITED, Kawasaki-shi (JP)

(21) Appl. No.: 15/180,308

(22) Filed: Jun. 13, 2016

(30) Foreign Application Priority Data
Jul. 31, 2015 (JP) 2015-152216

(51) Int. Cl. H04L 12/707; H04L 12/24

(52) U.S. Cl. CPC H04L 45/22; H04L 41/0654

(57) ABSTRACT

A detection process of a signal failure based on a reception state for a protection communication path is controlled in response to a routing control for a partial section of work and protection communication paths set between end nodes.

### CROSS-REFERENCE TO RELATED APPLICATION

This application is based upon and claims the benefit of priority of the prior Japanese Patent application No. 2015-152216, filed on Jul. 31, 2015, the entire contents of which are incorporated herein by reference.

### FIELD

The embodiment(s) discussed herein is related to a protection method, a communication system, and an end node.

### BACKGROUND

As an example of the protection technology of a network, a “1:1 protection” technology is known. In the “1:1 protection” technology, work and protection communication paths are set between end nodes and the work communication path is switched to the protection communication path in response to a communication failure of the work communication path.

### RELATED ART DOCUMENTS LIST

Patent Document 1: JP 2008-60784 A
Patent Document 2: JP 2011-188046 A
Patent Document 3: WO 2011/065908
Patent Document 4: WO 2007/086157
Non-Patent Document 1: ITU-T Recommendations G. 8013
Non-Patent Document 2: ITU-T Recommendations G. 8021
Non-Patent Document 3: ITU-T Recommendations G. 8031
Non-Patent Document 4: Yimin Shen et al., “PW Endpoint Fast Failure Protection” (draft-ietf-pwe3-endpoint-fast-protection-02.txt), Jan. 21, 2015

The work and protection communication paths set between end nodes may be set across another network that is different from the network to which the end nodes belong. In such a case, a partial section of the work and protection communication paths set between the end nodes passes through the other network.

In the other network to which a first protection technology different from a second protection technology between the end nodes is applied, when the other network operates according to the first protection technology, a mismatch arise in protection operations between the end nodes. It would result in a failure in relieving communications.

### SUMMARY

In one aspect, a protection method may include the following processes:

(a) Process of performing a switching control of work and protection communication paths set between end nodes in a first network, based on a reception state for each of signals transmitted to the communication paths

(b) Process of performing a routing control for a partial section of the communication paths, the partial section belonging to a second network

(c) Process of controlling, in response to the routing control for the partial section in the second network, a detection process of a signal failure based on the reception state for the signals for the protection communication path

In another aspect, a communication system may include a first network, a second network, and a controller. The first network may perform a switching control of work and protection communication paths set between end nodes, based on a reception state for each of signals transmitted to the communication paths. The second network may perform a routing control for a partial section of the communication paths, the partial section belonging to the second network. The controller may control, in response to the routing control for the partial section in the second network, a detection process of a signal failure based on the reception state of the signal for the protection communication path.

In still another aspect, an end node of work and protection communication paths set in a first network may include a first receiver, a second receiver, and a controller. The first receiver may receive a signal from the work communication path. The second receiver may receive a signal from the protection communication path. The controller may perform a switching control of the communication paths, based on a reception state for each of the signals in the first receiver and the second receiver. The controller may also control a detection process of a signal failure for the protection communication path based on the reception state for the signals in the second receiver, in response to a routing control in a second network for a partial section of the work and protection communication paths. The partial section belongs to the second network.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating a configuration example of a communication system according to an embodiment;

FIG. 2 is a block diagram illustrating an example in which a multi-protocol label switching (MPLS) network is overlaid on Ethernet (registered trademark) in the communication system illustrated in FIG. 1;

FIG. 3 is a block diagram illustrating a protection technology in the MPLS network illustrated in FIG. 2;

FIG. 4 is a block diagram illustrating the protection technology in the MPLS network illustrated in FIG. 2;

FIGS. 5 to 7 are diagrams illustrating a “1:1 protection” operation example between end nodes;

FIGS. 8 and 9 are diagrams illustrating a protection operation example when the MPLS network illustrated in FIGS. 3 and 4 is interposed between the end nodes illustrated in FIGS. 5 to 7;

FIG. 10 is a diagram schematically illustrating an example in which a failure occurs on a work communication path outside the MPLS network in FIG. 8;

FIG. 11 is a flow chart illustrating an operation example of the end node according to an embodiment;

FIG. 12 is a block diagram illustrating a configuration example of the end node according to an embodiment;

FIG. 13 is a block diagram illustrating a configuration example of a controller illustrated in FIG. 12;

FIGS. 14 and 15 are diagrams illustrating an operation example when the MPLS network illustrated in FIG. 9 recovers from a failure that occurred in the network;

FIG. 16 is a block diagram schematically illustrating an example in which a failure of node occurs in the MPLS network illustrated in FIG. 9;

FIG. 17 is a block diagram schematically illustrating a protection operation when the failure of node illustrated in FIG. 16 changes to a failure of port;

FIG. 18 is a flow chart illustrating another operation example of the end node illustrated in FIGS. 12 and 13; and

FIG. 19 is a diagram illustrating a format example of an automatic protection switching (APS) signal.

### DESCRIPTION OF EMBODIMENTS

Hereinafter, an embodiment will be described with reference to the drawings. However, the embodiment described below is only by way of example and does not intend to exclude application of various modifications and technologies that are not explicitly shown below. Also, various illustrative forms described below may appropriately be combined and carried out. In the drawings used for the embodiment below, portions to which the same reference sign is attached represent the same or similar portions unless otherwise mentioned.

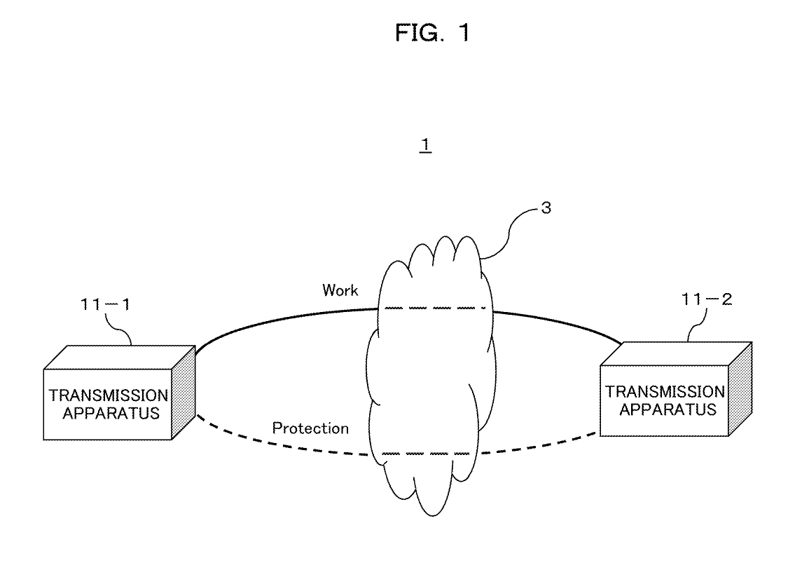

FIG. 1 is a block diagram illustrating a configuration example of a communication system according to an embodiment. A communication system 1 illustrated in FIG. 1 may illustratively include transmission apparatuses 11-1 and 11-2 and a network 3.

The communication system 1 may simply be referred to as a “network 1”. The “transmission apparatus” may be called a “communication apparatus” or a “communication node” or simply a “node”. The network 1 is an example of a first network, and the network 3 is an example of a second network.

The nodes 11-1 and 11-2 are illustratively examples of an element (network element, NE) of the certain network 1 different from the network 3. In other words, the network 3 is overlaid on the network 1 to which the nodes 11-1 and 11-2 belong. Thus, the network 3 may be referred to as an “overlay network 3”.

Examples of the network 1 to which the nodes 11-1 and 11-2 belong may be a frame-relay (FR) network, an asynchronous transfer mode (ATM) network, or Ethernet (registered trademark). Examples of the network 3 may be an MPLS (Multi-Protocol Label Switching) network.

In the network 1, the nodes 11-1 and 11-2 can mutually communicate via (may also be referred to as “across”) the overlay network 3.

The nodes 11-1 and 11-2 can communicate with each other without regard to the network 3 interposed therebetween by, for example, a signal transmitted through the network 1 being encapsulated in a signal of the network 3 in the overlay network 3.

In other words, the nodes 11-1 and 11-2 are available to transparently communicates with each other via the network 3. The “encapsulation” may also be referred to as “tunneling”. In the MPLS, labeling of a signal may be considered to correspond to the “encapsulation”.

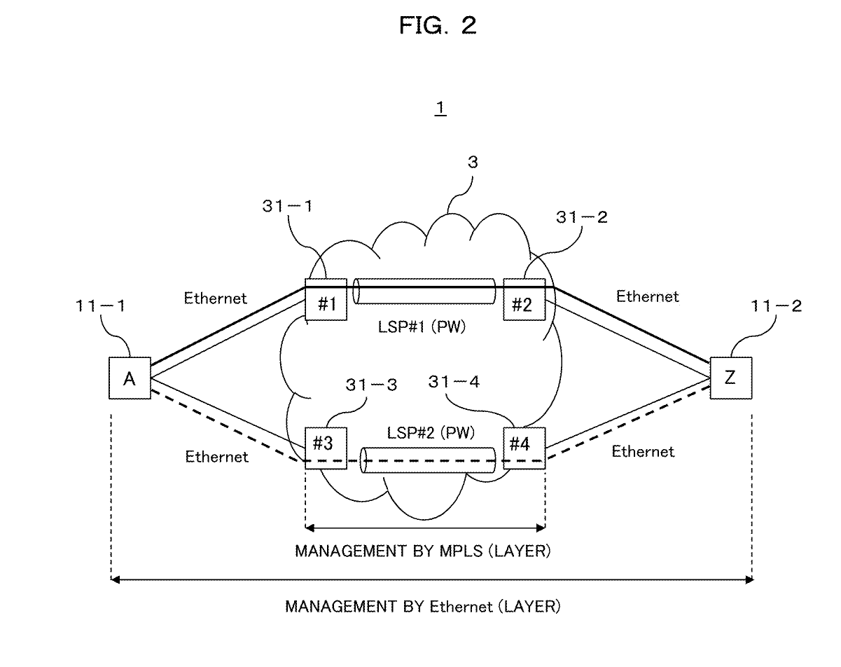

FIG. 2 illustrates, as a non-restrictive example, a configuration example in which the network 1 is the Ethernet (registered trademark) and the overlay network 3 is an MPLS network. In the example of FIG. 2, the MPLS network 3 includes a plurality (four units in the example of FIG. 2) of nodes (#1 to #4) 31-1 to 31-4. When there is no need to distinguish each of the nodes 31-1 to 31-4, each node 31-1 to 31-4 may collectively be referred to as “node 31”.

The node 31 as NE of the MPLS network 3 may be a label switching router (LSR).

LSR positioned at an edge of the MPLS network 3 may be referred to as an edge LSR or a label edge router (LER).

The edge LSR is available to attach a label of MPLS to a signal received from Ethernet 1 and to transfer the signal to the next hop in the MPLS network 3. The edge LSR is also available to remove a label attached to a received signal and transfer the signal to Ethernet 1.

A signal transmitted through Ethernet 1 is illustratively an Ethernet frame to which user data is mapped. The Ethernet frame may also be referred to as an Ethernet signal. An Ethernet signal to which user data is mapped may be referred to as a “user signal” or “user traffic”.

An LSR available to attach a label may be referred to as an “ingress LSR” and an LSR available to remove (or de-attach) the label may be referred to as an “egress LSR”.

An LSR not corresponding to the edge LSR is available to receive a signal to which a label is attached and to re-attach another label thereto in the MPLS network 3.

Each of the nodes #1 to #4 illustrated in FIG. 2 illustratively corresponds to an edge LSR. For example, in FIG. 2, upon focusing on communication in the direction from the node (A) 11-1 to the node (Z) 11-2, LSRs#1 and #3 each corresponds to an ingress LSR that attaches a label to a user signal received from the node A. LSRs#2 and #4 corresponds to an egress LSR that removes a label of a user signal received from LSRs#1 and #3 and transmits the signal to the node Z, respectively.

In the MPLS network 3, a label switching path (LSP) may be set to between LSRs#1 and #2 and between LSRs#3 and #4. The LSP set between LSRs#1 and #2 may be referred to as “LSP#1” and the LSP set between LSRs#3 and #4 may be referred to as “LSP#2”. The LSP#1 and #2 may provide a pseudo wire (PW) of Ethernet 1.

For example, the LSR#1 attaches a label corresponding to the identifier of a user signal received from the node A to the user signal and forwards the signal to a relevant port of LSP#1. The identifier of a user signal may be a virtual local area network identifier (VLAN ID).

Similarly, the LSR#3 attaches a label corresponding to the identifier of a user signal received from the node A to the user signal and forwards the signal to a relevant port of LSP#2.

The LSR#2 identifies the identifier of a user signal received from the LSP#1 based on the label attached to the user signal and forwards the user signal from which the label has been removed to a relevant port reachable to the destination node Z corresponding to the identifier.

Similarly, the LSR#4 identifies the identifier of a user signal received from the LSP#2 based on the label attached to the user signal and forwards the user signal from which the label has been removed to a relevant port reachable to the destination node Z corresponding to the identifier.

A user signal transmitted from the node A can transparently reach, as described above, the destination node Z via the LSP#1 or #2 in the MPLS network 3.

Similarly, a signal addressed to the node A from the node Z can transparently reach the destination node A via the LSP#1 or #2 in the MPLS network 3.

Incidentally, LSP may be made redundant in the MPLS network 3 for the purpose of improving reliability of communication. For example, an alternative LSP (may also be referred to as a “bypass LSP”) may be set to some LSPs. The bypass LSP may be set inside and closed under the MPLS network 3 and may be additionally set independent to the communication path between the nodes A and Z.

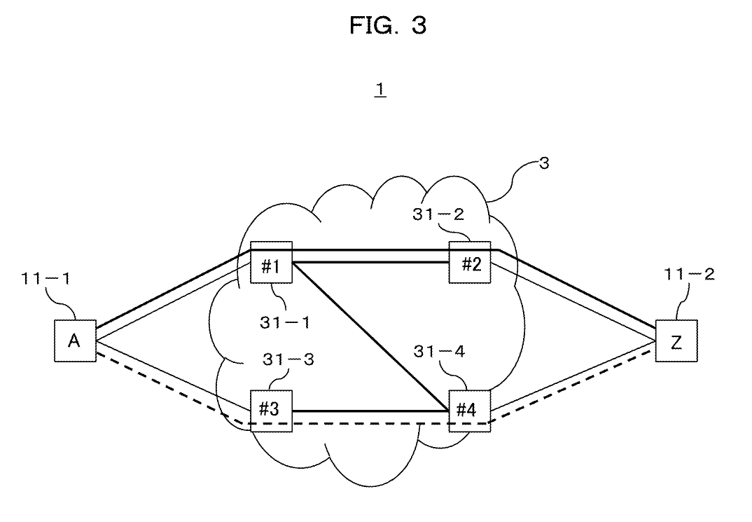

For example, as illustrated in FIG. 3, a bypass LSP may be set between LSR#1 and LSR#4. A bypass LSP may also be set between LSR#2 and LSR#3.

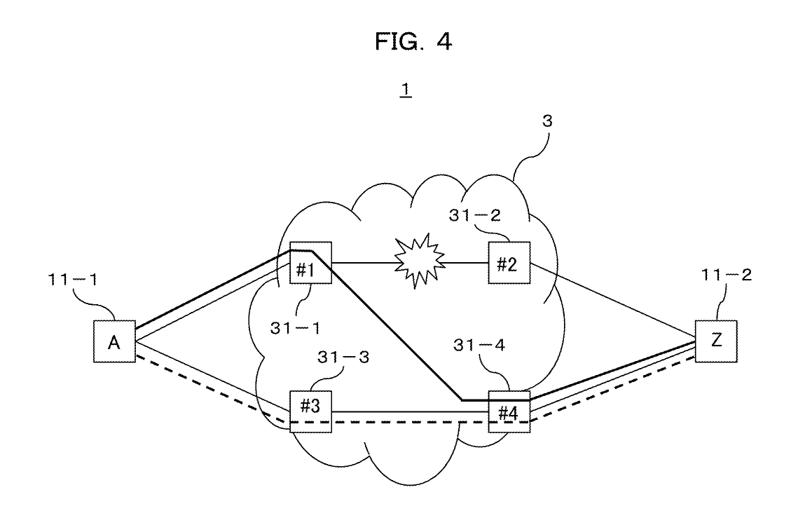

It is assumed here that, as illustrated in FIG. 4, a failure occurred on LSP#1 between LSR#1 and #2 during communications are performed on a route from the node A to the node Z via LSP#1.

In this case, by performing a routing control to switch the failure-occurred LSP#1 to a bypass LSP between LSR#1 and LSR#4, the communication in the direction from the node A to the node Z can be continued. Therefore, the bypass LSP may be considered to correspond to a protection LSP for a work LSP#1.

Even when LSP#1 is switched to a bypass LSP, for example, operations of LSRs#1, #2 and #4 involved in switching are unchanged as a forwarding operation based on the correspondence between the label and identifier. Thus, forwarding of a user signal is maintained before and after switching of LSP.

Therefore, communication from the node A to the node Z is normally continued. Communication in the opposite direction from the node Z to the node A can similarly be continued correctly via the bypass LSP.

However, there is a case where a protection operation between the nodes A and Z does not correctly work when a partial section between the nodes A and Z goes via the MPLS network 3 and when a unique routing control is performed by using a bypass LSP in the MPLS network 3.

For example, “1:1 protection” (may also be referred to as “linear protection”) may be set to between the nodes A and Z corresponding to an end-to-end.

In the “1:1 protection”, for example, one of two communication paths (or routes) reachable in the end-to-end is set as a work and the other is set as a protection.

The work communication path may be referred to as a “work system” and the protection communication path may be referred to as a “protection system”. When a failure occurs in the work system, communications in the work system can be relieved by the protection system by switching the work system to the protection system.

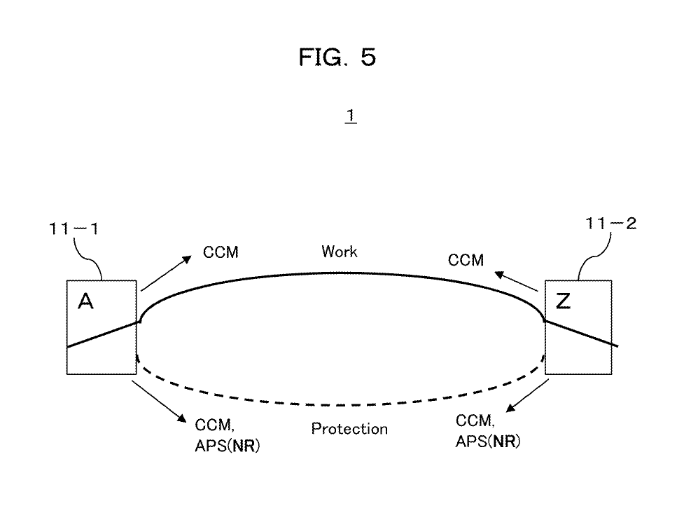

FIGS. 5 to 7 illustrate a “1:1 protection” operation example between the nodes A and Z. As illustrated in FIG. 5, the node A and the node Z each select the work system to perform communications during normal operation.

On the other hand, the node A and the node Z each may check a state (for example, continuity) of each system by periodically (or non-periodically) transmitting a control signal to both of the work and protection systems.

As a control signal to check continuity, a continuity check message (CCM) of Ethernet OAM technology is applicable, for example. The CCM is an example of a first signal transmitted to both of the work and protection systems. OAM is an abbreviation of “Operation, Administration, and Maintenance”.

A loss of the continuity of the work system or the protection system can be detected when no reception of the CCM continues for a predetermined time. The loss of continuity may also be detected as a loss of continuity (LOC) error of the CCM.

During normal operation, the node A and the node Z each may periodically (or non-periodically) transmit a control signal (may be referred to as an “automatic protection switching (APS) signal”) based on an APS protocol to the protection system. The APS signal is an example of a second signal transmitted to the protection system.

The APS signal used in normal operation may be set to include information indicative of no request (NR) to a node corresponding to a maintenance end point (MEP) of the OAM. In the example of FIG. 5, the nodes A and Z correspond to the MEP.

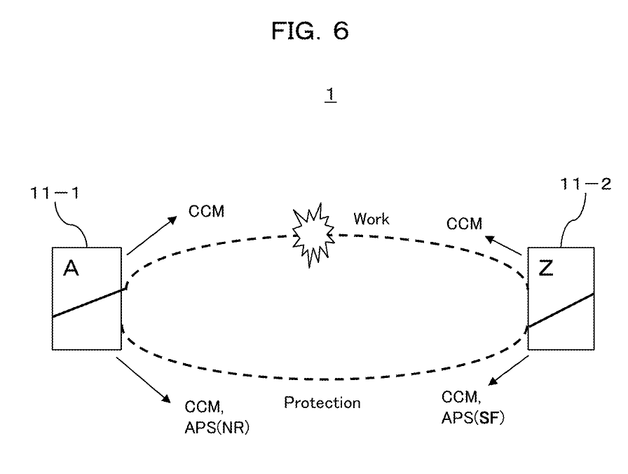

After that, it is assumed that, as illustrated in FIG. 6, a failure occurs in the work system in the direction from the node A to the node Z. In this case, CCM transmitted to the work system by the node A does not reach the node Z, and thus, the node Z detects a reception failure of the CCM.

In response to a detection of the reception failure of the CCM, the node Z switches the work system to the protection system and sets information indicative of a signal failure (SF) to an APS signal to be transmitted to the protection system reachable to the node A.

An APS signal to which information indicative of the NR is set may be referred to as an “APS (NR) signal” and an APS signal to which information indicative of the SF is set may be referred to as an “APS (SF) signal”.

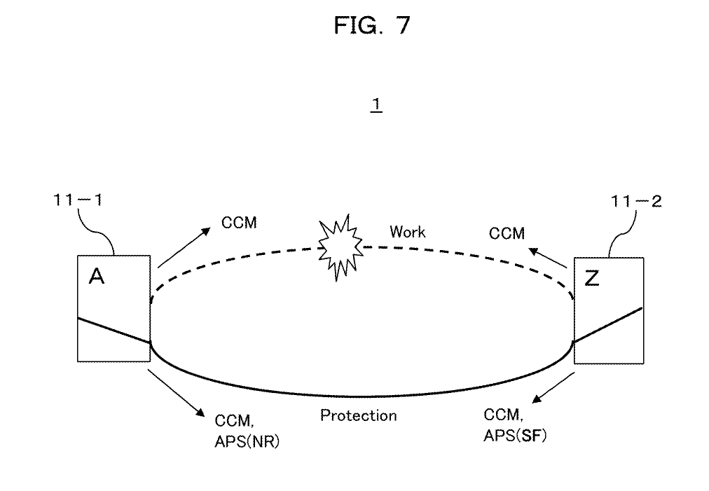

When the node A detects a reception of an APS (SF) signal from the protection system, as illustrated in FIG. 7, the node A switches the work system to the protection system.

Thereby, switching to the protection system of both of the nodes A and Z is completed, and the nodes A and Z are available to continue communication through the protection system.

The “1:1 protection” described above is discussed in the ITU-T Recommendations G.8031, G.8013, and Y.1731, for example.

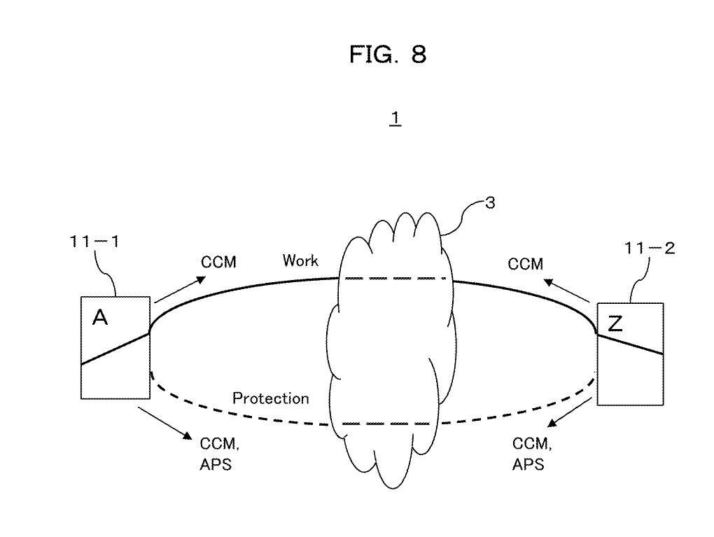

However, as illustrated in FIG. 8, when the MPLS network 3 that uses a unique routing control as illustrated in FIGS. 3 and 4 is interposed between the nodes A and Z of the network 1, a mismatch in protection operations between the nodes A and Z may be occurred.

When a switching to a bypass LSP occurs in the MPLS network 3 due to a failure occurred in an LSP, for example, there is a case where a transmission of the CCM and/or the APS signal based on the APS protocol does not properly work.

Thus, there is a case where one of the nodes A and Z switches the work system to the protection system but the other node does not perform the switching of the systems and maintains to select the work system.

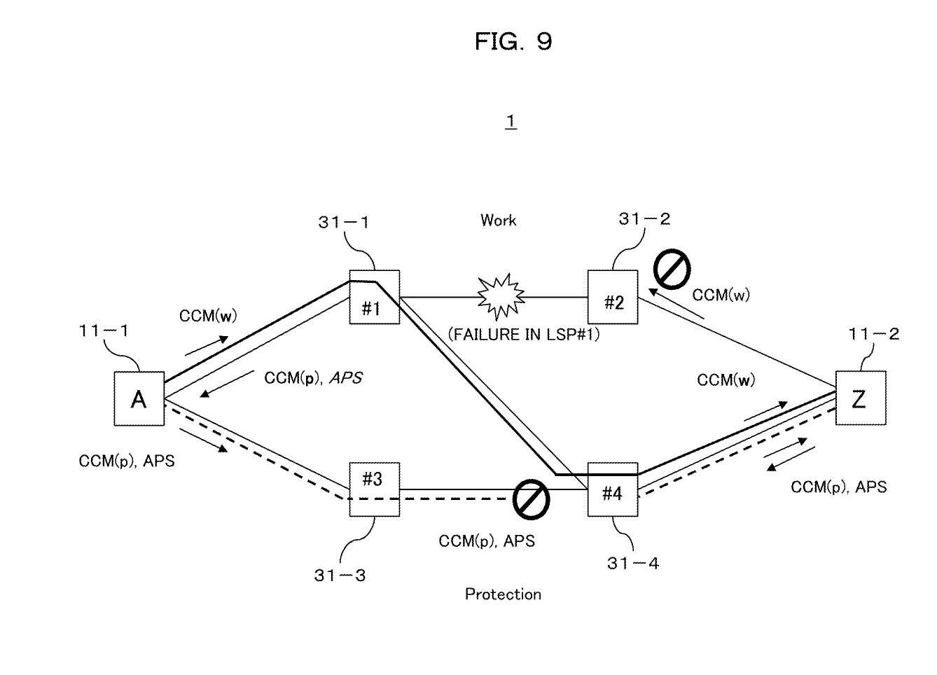

FIG. 9 illustrates an example in which a mismatch in protection operations of the nodes A and Z arise. The nodes A and Z may each transmit, as described above, a CCM to both of the work system and the protection system during normal operation.

Also, the nodes A and Z may each transmit an APS signal to the protection system. In FIG. 9, the CCM transmitted to the work system is represented as “CCM(w)” and the CCM transmitted to the protection system is represented as “CCM(p)”.

It is assumed that, as illustrated in FIG. 9, like in FIG. 4, a failure occurs on LSP#1 between LSRs#1 and #2 in the MPLS network 3 and LSP#1 is disconnected. In this case, in the MPLS network 3, as described with reference to FIG. 4, LSP#1 between LSRs#1 and #2 is switched to the bypass LSP between LSRs#1 and #4.

Thus, the CCM(w) transmitted to the work system by the node A reaches to the node Z via the bypass LSP between LSRs#1 and #4. Meanwhile, the CCM(p) and APS signals transmitted to the protection system by the node Z reach to the node A via the bypass LSP between LSRs#1 and #4.

The CCM(p) and APS signals transmitted to the protection system by the node A reach to LSR#4 via LSR#3 but do not reach to the node Z because LSR#4 is switched to the bypass LSP and forwarding based on the label is not properly performed.

Also, the CCM(w) transmitted to the work system by the node Z reaches to LSR#2 but does not reach to LSR#1 and the node A because LSP#1 between LSRs#1 and #2 is disconnected.

The node A receives the CCM(p) and the APS signals transmitted to the protection system by the node Z from the work system. However, the CCM(p) is originally intended to be received from the protection system.

Thus, when the CCM(p) is received from the work system, the node A detects a signal failure (SF) of the work system because of the reception of an unexpected signal (Unexpected MEP).

In addition, the node A receives the CCM(p) and the APS signals transmitted to the protection system by the node Z from the work system, and thus, the node A does not receive the CCM(p) and the APS signals from the protection system.

Since the CCM(p) is not received from the protection system, the node A detects an LOC error of the protection system after no reception of the CCM(p) continues for a predetermined time. In the node A, in response to the detection of the LOC error, an SF of the protection system is detected (or asserted).

Also, since no APS signal is received from the protection system, the node A detects a reception timeout error of the APS signal due to a continuation of no reception of the APS signal for a predetermined time.

The reception timeout error of the APS signal may be referred to as a “defect failure of protocol-time out, dFOP-TO” error. The dFOP-TO error is defined in ITU-T Recommendations G. 8021, for example.

Since the APS protocol for the work system may be undefined, the node A does not have to process APS signals received from the work system (in other words, may ignore APS signals).

The node A detects the SF for both of the work system and the protection system and also detects an APS reception timeout (dFOP-TO) error as described above and so recognizes that a failure has occurred in the protection system. Therefore, the node A maintains the selection of the work system without switching to the protection system.

On the other hand, in the node Z, since the CCM(w) is not received from the work system, the node Z detects an LOC error of the work system due to a continuation of no reception of CCM(w) for a predetermined time. In the node Z, in response to the detection of the LOC error, an SF of the work system is detected (or asserted).

The CCM(w) sent to the work system by the node A is transmitted to the protection system toward the node Z via the bypass LSP between LSR#1 and #4, and thus, the node Z receives the CCM(w) of the work system from the protection system.

Since the node Z receives the CCM(w) of the work system from the protection system, the node Z detects an SF of the protection system due to the reception of an unexpected signal (Unexpected MEP).

An APS signal transmitted to the protection system by the node A does not reach the node Z because, as described above, LSR#4 is switched to the bypass LSP.

Since no APS signal is received from the protection system, the node Z detects an APS reception timeout (dFOP-TO) error due to a continuation of no reception of the APS signal for a predetermined time.

Like the node A, since the node Z detects the SF for both of the work and protection systems and also detects the dFOP-TO error as described above, the node Z recognizes that a failure has occurred in the protection system. Therefore, like the node A, the node Z maintains the selection of the work system without switching to the protection system.

However, when the node Z does not select the protection system, a user signal transmitted via the bypass LSP between LSRs#1 and #4 in the MPLS network 3 will be discarded even when the user signal is reached to the node Z via the protection system.

As a result, the communication from the node A to the node Z is blocked. In other words, there is a case where the communication between the nodes A and Z corresponding to the end-to-end communication of the network 1 is blocked because a protection operation to relieve a user signal addressed to the node Z from the node A with the bypass LSP is effectively worked in the MPLS network 3.

One of the causes is that, for example, the CCM(w) of the work system is erroneously merged with (in other words, leaked into) the protection system in response to switching to the bypass LSP in the MPLS network 3.

In other words, when the CCM(w) of the work system is erroneously merged with the protection system, the node Z detects a reception of an unexpected signal for the protection system. Thus, the node Z erroneously detects the SF of the protection system that is originally to be select to receive a user signal.

To avoid such mismatch in protection operations between the nodes A and Z as described above, there is an option not to apply the “1:1 protection” technology based on the APS protocol to between the nodes A and Z in an overlaid network configuration.

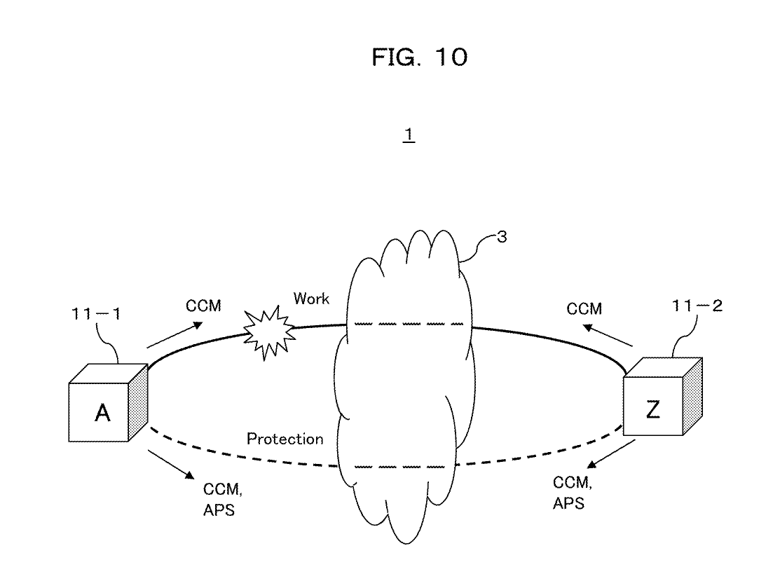

In such a case, however, as schematically illustrated in FIG. 10, switching to the protection system is disabled when a failure occurs in the work system outside the MPLS network 3 between the nodes A and Z.

Therefore, it is preferable to achieve a coexistence of an end-to-end protection operation based on the APS protocol in the network 1 and the routing control for the overlaid network 3.

In other words, it is preferable to ensure the end-to-end protection operation in the network 1 without being affected by the routing control performed in the overlaid network 3.

The present embodiment, therefore, focuses on the facts that the SF detection depends on the CCM and the APS process is limitedly defined for the protection system in an end node (A or Z).

For example, when Condition 1 and Condition 2 listed below are satisfied in an end node (for example, the node Z in FIG. 9) that has detected the reception of CCM(w) of the work system flowing into the protection system, the end node may inhibit “Unexpected MEP” error detection for the protection system regardless of the reception of CCM(w).

Condition 1: The source of CCM(w) of the work system is a registered correspondent end node (MEP).

Condition 2: An APS reception timeout (dFOP-TO) error of the protection system is detected.

The inhibiting detection of an “Unexpected MEP” error for the protection system may be considered as corresponding to processing a reception of CCM(w) from the protection system not as an erroneous reception but as a normal reception.

When a detection of an “Unexpected MEP” error for the protection system is inhibited, a detection of SF of the protection system caused by the detection of an “Unexpected MEP” error is also inhibited.

As a result, in the example of FIG. 9, the end node Z is in a state where no SF of the protection system is detected and the SF due to a LOC error detection of the work system is detected.

Therefore, the end node Z switches the work system to the protection system in response to the SF detection of the work system. In the end node A, as described with reference to FIG. 9, the SF is detected for both of the work and protection systems and also the APS reception timeout for the protection system is detected. Thus, the end node A recognizes that a failure has occurred in the protection system and does not perform switching to the protection system to maintain the selection of the work system.

Accordingly, the communication from the node A to the node Z via the work system, the bypass LSP between LSR#1 and #4, and the protection system is correctly continued.

### Operation Example

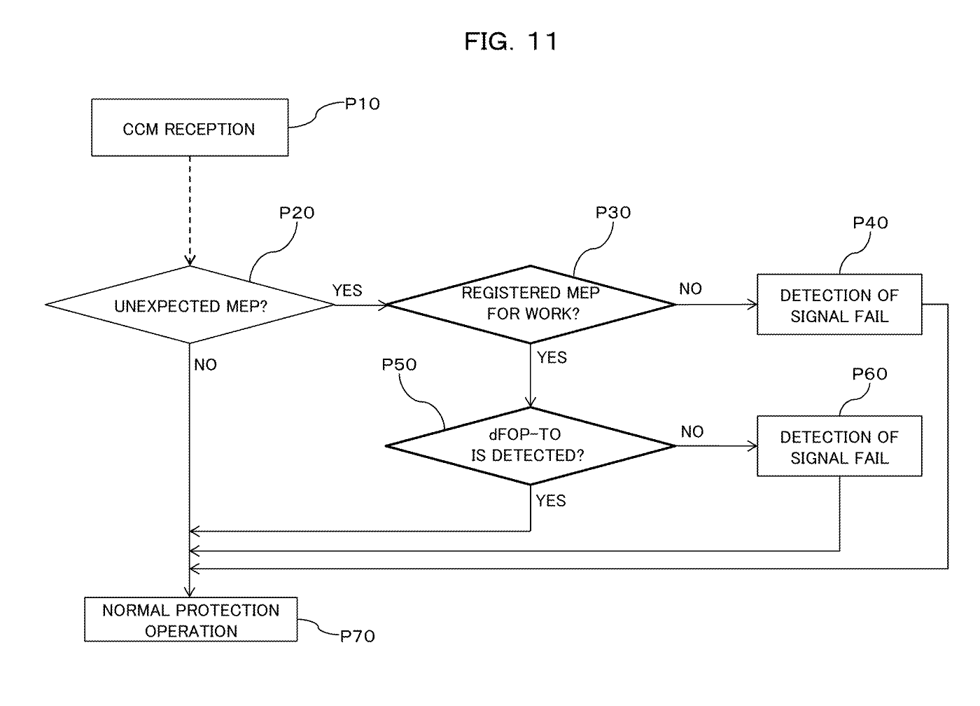

Hereinafter, an operation example focusing on the protection system at the node Z will be described with reference to the flow chart illustrated in FIG. 11. An operation example focusing on the protection system at the node A for communication in the opposite direction from the node Z to the node A may be understood that the flow chart in FIG. 11 is performed in the node A.

When CCM is received (Process P10), the node Z checks whether the CCM is an unexpected signal (Unexpected MEP) (Process P20).

As a result of the check, when the received CCM is not an unexpected signal (NO in Process P20), the node Z may perform a normal protection operation (Process P70). The normal protection operation may be, for example, an operation illustrated in “Figs. 8-19” of the ITU-T Recommendations G. 8021.

On the other hand, if the received CCM is an unexpected signal (YES in Process P20), the node Z may further check whether registered MEP of the work system is set to the received CCM without asserting an “Unexpected MEP” error (Process P30).

As a result of the check, when registered MEP of the work system is not set to the received CCM (NO in Process P30), as described with reference to FIG. 9, the node Z asserts an “Unexpected MEP” error and detects SF (Process P40). The SF detection corresponds to an operation compliant with the ITU-T Recommendations G. 8021, and thereafter, the node Z may perform a normal protection operation (Process P70).

On the other hand, when registered MEP of the work system is set to the received CCM (YES in Process P30), the node Z may check whether or not a dFOP-TO error is detected (Process P50).

In other words, the CCM reception of the registered MEP is not processed as the “Unexpected MEP” and thereby inhibiting the asserting of an “Unexpected MEP” error. By checking whether the received CCM is an CCM of the registered MEP in Process P30, it is possible to avoid an erroneous assertion or de-assertion of an “Unexpected MEP”.

When a dFOP-TO error is not detected (NO in Process P50), the node Z detects an SF (Process P60). Like Process P40, the SF detection also corresponds to an operation compliant with the ITU-T Recommendations G. 8021, and thereafter, the node Z may perform a normal protection operation (Process P70). NO is determined in Process P50 when the node Z receives a CCM(w) and an APS signal from the work system.

On the other hand, when a dFOP-TO error is detected (YES in Process P50), Condition 1 and Condition 2 described above are satisfied, and thus, the node Z may perform a normal protection operation without asserting an SF of the protection system (Process P70).

When the CCM transmitted to the work system is received from the protection system while no APS signal is received from the protection system, as described above, the node Z inhibits an assertion of SF for the protection system.

Accordingly, in the node Z, since only the work system among the work system and the protection system is under a state where an SF is asserted, it is possible to continue a reception with the protection system by switching from the work system to the protection system.

### Node Configuration Example

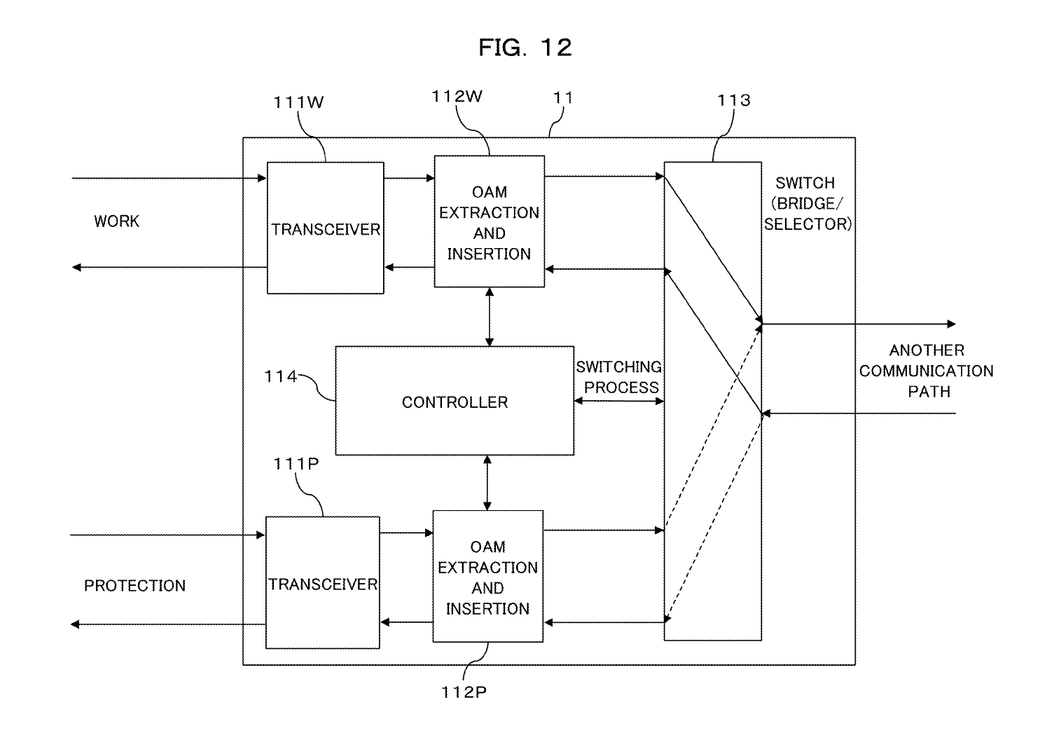

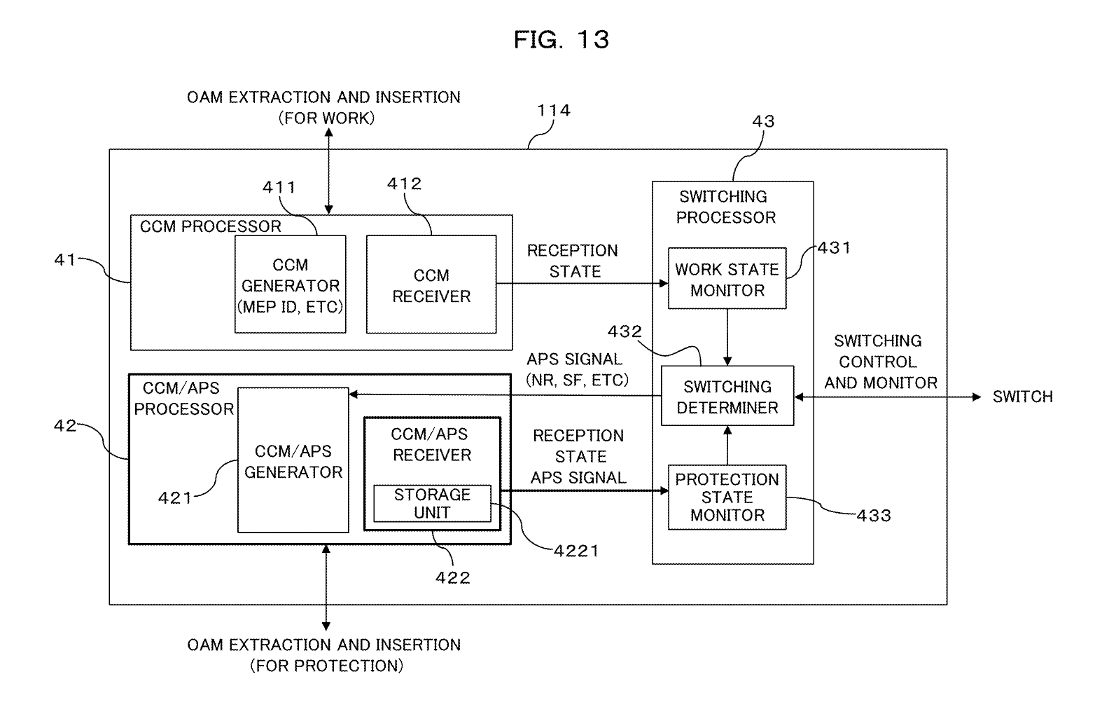

Next, a configuration example of a node 11 available to achieve the above operation example will be described with reference to FIGS. 12 and 13.

FIG. 12 is a block diagram illustrating a configuration example of the node 11 (for example, the node Z or A) described above.

The node 11 illustrated in FIG. 12 may include a transceiver 111W and an OAM extraction and insertion unit 112W for the work system and a transceiver 111P and an OAM extraction and insertion unit 112P for the protection system. Also, the node 11 may include a switch 113 and a controller 114.

The transceiver 111W for the work system transmits a signal to the work system and/or receives a signal from the work system, for example. Signals transmitted and received by the transceiver 111W for the work system may include user signals and control signals (for example, an OAM signal). Examples of the OAM signal include the CCM and the APS signals described above.

The OAM extraction and insertion unit 112W for the work system may extract an OAM signal from a signal stream received by the transceiver 111W for the work system. Also, the OAM extraction and insertion unit 112W may insert an OAM signal into a signal stream transmitted to the work system from the transceiver 111W for the work system.

Upon focusing on a reception process of the work system, the transceiver 111W and the OAM extraction and insertion unit 112W for the work system may be considered as being an example of a first receiver.

The transceiver 111P for the protection system transmits a signal to the protection system and/or receives a signal from the protection system, for example. Signals transmitted and received by the transceiver 111P for the protection system may include, like the work system, user signals and control signals (for example, an OAM signal).

The OAM extraction and insertion unit 112P for the protection system may extract an OAM signal from a signal stream received by the transceiver 111P for the protection system. Also, the OAM extraction and insertion unit 112P may insert an OAM signal into a signal stream transmitted to the protection system from the transceiver 111P for the protection system.

Upon focusing on a reception process of the protection system, the transceiver 111P and the OAM extraction and insertion unit 112P for the protection system may be considered as being an example of a second receiver.

OAM signals extracted by each of the OAM extraction and insertion unit 112W for the work system and the OAM extraction and insertion unit 112P for the protection system may be provided to the controller 114.

An OAM signal generated by the controller 114 and directed to the work system may be provided to the OAM extraction and insertion unit 112W for the work system. An OAM signal generated by the controller 114 and directed to the protection system may be provided to the OAM extraction and insertion unit 112P for the protection system.

The switch 113 performs switching (may also be referred to as a “selection”) of the work system and the protection system by switching an internal signal route in response to the control by the controller 114. A bridge or a selector may be applied to the switch 113.

The controller 114 controls a generation of an OAM signal as an example of the control signal, an APS process based on an OAM signal, switching of the work system and the protection system in response to an APS process, for example.

FIG. 13 illustrates a configuration example of the controller 114. The controller 114 illustrated in FIG. 13 may include a CCM processor 41, a CCM/APS processor 42, and a switching processor 43.

The CCM processor 41 may handle processing of the CCM for the work system and may include a CCM generator 411 and a CCM receiver 412.

The CCM generator 411 may generate a CCM to be transmitted to the work system. The CCM may have a frame format compliant with the ITU-T Recommendations G. 8013.

The identifier of MEP (MEP ID) set to the frame format may be information available to identify a port of the work system. Therefore, even when a plurality of ports of the work system is provided, it is possible to identify a source port of the CCM based on the MEP ID.

The CCM generated by the CCM generator 411 may be provided to the OAM extraction and insertion unit 112W to be transmitted to the work system through the transceiver 111W for the work system.

The CCM receiver 412 receives a CCM extracted by the OAM extraction and insertion unit 112W for the work system, for example. In response to the reception of CCM, the CCM receiver 412 may notify the switching processor 43 (for example, a work state monitor 431 described below) of a reception state of CCM.

Here, the CCM receiver 412 for the work system may perform a process compliant with the ITU-T Recommendations G.8013 and G. 8021. For example, when a CCM(p) of the protection system is received from the work system, the CCM receiver 412 may detect an “Unexpected MEP” error and assert an SF. The CCM receiver 412 may also detect a LOC error and assert an SF when a no reception state of CCM(w) of the work system continues for a predetermined time. The asserted SF may be notified to the switching processor 43 (for example, the work state monitor 431 described below).

The CCM/APS processor 42 may handle processing of the CCM and the APS signals for the protection system and may include a CCM/APS generator 421 and a CCM/APS receiver 422.

The CCM/APS generator 421 may generate a CCM and APS signals to be transmitted to the protection system. The generated CCM or APS signals may be provided to the OAM extraction and insertion unit 112W to be transmitted to the protection system through the transceiver 111P of the protection system. As described above, information indicative of the NR or the SF may be set to the APS signals to be transmitted to the protection system.

The CCM/APS receiver 422 receives a CCM or an APS signal extracted by the OAM extraction and insertion unit 112P for the protection system, for example. In response to the reception of CCM or an APS signal, the CCM/APS receiver 422 may notify the switching processor 43 (for example, a protection state monitor 433 described below) of the reception of CCM or an APS signal.

The CCM/APS receiver 422 for the protection system may operate according to the flow chart illustrated in FIG. 11.

For example, the CCM/APS receiver 422 does not assert an SF when a registered MEP of the work system is set to an received CCM(w) of the work system, which is received from the protection system. Meanwhile, when a registered MEP is not set to the received CCM(w), the CCM/APS receiver 422 may assert an SF. The asserted SF may be notified to the switching processor 43 (for example, the protection state monitor 433 described below).

Information about the MEP of the work system may be registered and stored in a storage unit 4221 provided in the CCM/APS receiver 422. However, the storage unit 4221 may be provided inside the controller 114 or the node 11 and may be accessible from the CCM/APS receiver 422.

When a non-reception state of an APS signal of the protection system continues for a predetermined time, the CCM/APS receiver 422 may assert a dFOP-TO error and notify the switching processor 43 (for example, the protection state monitor 433 described below) of the error.

The switching processor 43 is available to determine the state of each of the work and protection systems based on notifications from the CCM receiver 412 and the CCM/APS receiver 422. Based on the determination result, the switching processor 43 may control switching of the switch 113. Also, the switching processor 43 may monitor a switching state of the switch 113.

As a non-restrictive example, the switching processor 43 may include a work state monitor 431, a switching determiner 432, and a protection state monitor 433.

The work state monitor 431 may monitor a state of the work system based on a notification from the CCM receiver 412 of the CCM processor 41. When an SF is asserted by the CCM receiver 412, for example, it is allowed to determine that a failure in the work system is occurred.

The protection state monitor 433 may monitor a state (for example, continuity, NR, SF and the like) of the protection system based on a notification from the CCM/APS receiver 422 of the CCM/APS processor 42. When an SF is asserted by the CCM/APS receiver 422, for example, it is allowed to determine that a failure in the protection system is occurred.

Based on the monitor result of each of the monitors 431 and 433, the switching determiner 432 may determine whether to perform switching between the work system and the protection system. In response to the result of the determination, the switching determiner 432 may control switching of the switch 113.

When an SF of the work system is not detected, for example, the switching determiner 432 may determine to continue to select the work system. On the other hand, when an SF of the work system is detected and an SF is not detected in the protection system (including a case when, as described above, an SF assertion is inhibited), the switching determiner 432 may determine to switch the work system to the protection system.

As described above, the controller 114 controls, in response to routing control in the MPLS network 3, the detection process of signal failure based on the reception state of signals of the protection system.

According to the control, even when the other network 3 is overlaid on the network 1 and a unique protection technology works in the other network 3, it is possible to appropriately ensure an end-to-end protection operation.

When, for example, the path of the Ethernet 1 is accommodated in the MPLS network 3, switching to the bypass LSP in the MPLS network 3 uses a so-called local repair technology to bypass specific LSR and so can be completed in a few tens of ms.

From the viewpoint of lower costs, the transmission cycle of CCM and APS signals in the Ethernet 1 as an example of an access network may be set to 100-ms to 1-s cycle. In such an environment, the switching time only needs to be implemented in 100 ms to 1 s at the slowest and so no problem is caused in terms of operation (conversely, CCM does not have to be made faster at high cost).

(Operation Example During Failure Recovery)

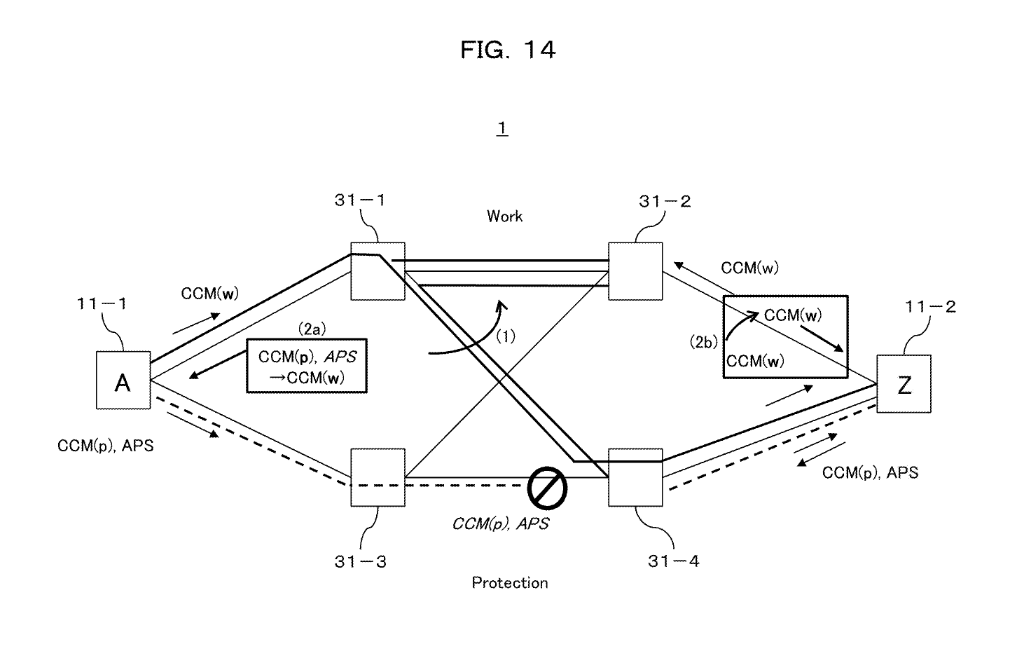

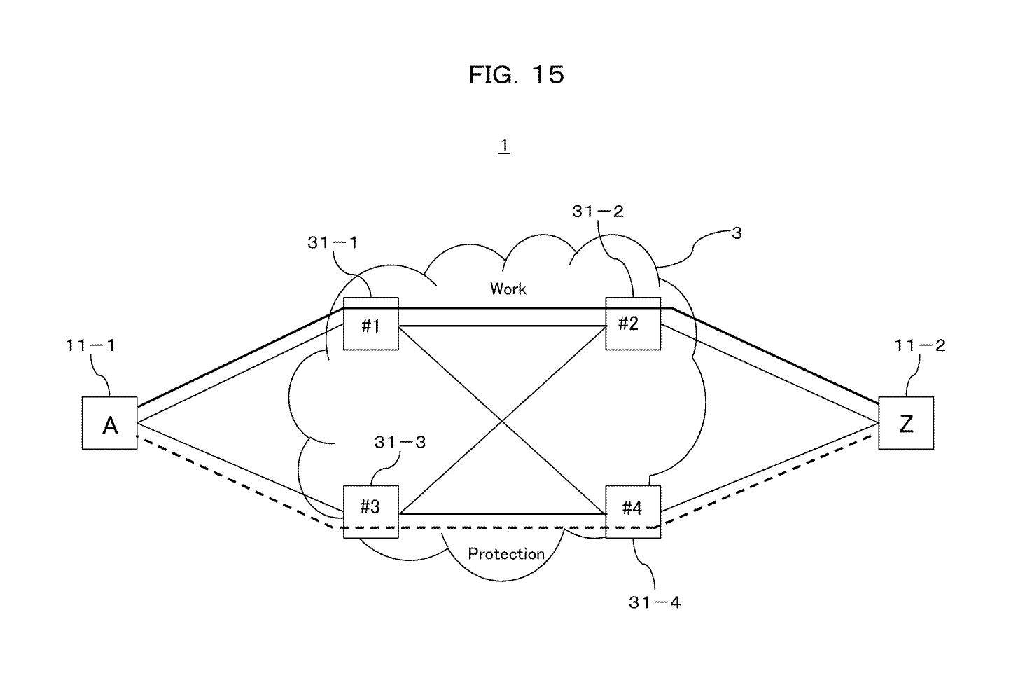

Next, an example of a recovery process when LSP#1 in the MPLS network illustrated in FIG. 9 recovers from the failure will be described with reference to FIGS. 14 and 15.

As illustrated in FIG. 14, it is assumed that LSP#1 recovers from the failure and the bypass LSP between LSRs#1 and #4 is switched back to the recovered LSP#1 (see (1) in FIG. 14).

When the bypass LSP is switched back to LSP#1, the node A no longer receives the CCM(p) and the APS signals transmitted to the protection system by the node Z from the work system. Alternatively, the node A receives the CCM(w) transmitted to the work system by the node Z and going through LSP#1 from the work system (see (2a) in FIG. 14). Therefore, the SF of the work system is no longer detected by the node A (in other words, the SF of the work system is de-asserted).

Meanwhile, the node Z receives the CCM(w), which has been transmitted to the work system by the node A and has been received from the protection system, from the work system (see (2b) in FIG. 14). Therefore, the SF of the work system is also no longer detected by the node Z (in other words, the SF of the work system is de-asserted).

In response to switching from the bypass LSP to LSP#1, each of the nodes A and Z is available to transceive CCM(p) and APS (NR) signals in the protection system.

Therefore, as illustrated in FIG. 15, both of the nodes A and Z select the work system to perform communications. The recovery process described above may be considered as corresponding to the recovery process defined in the ITU-T Recommendations G. 8031.

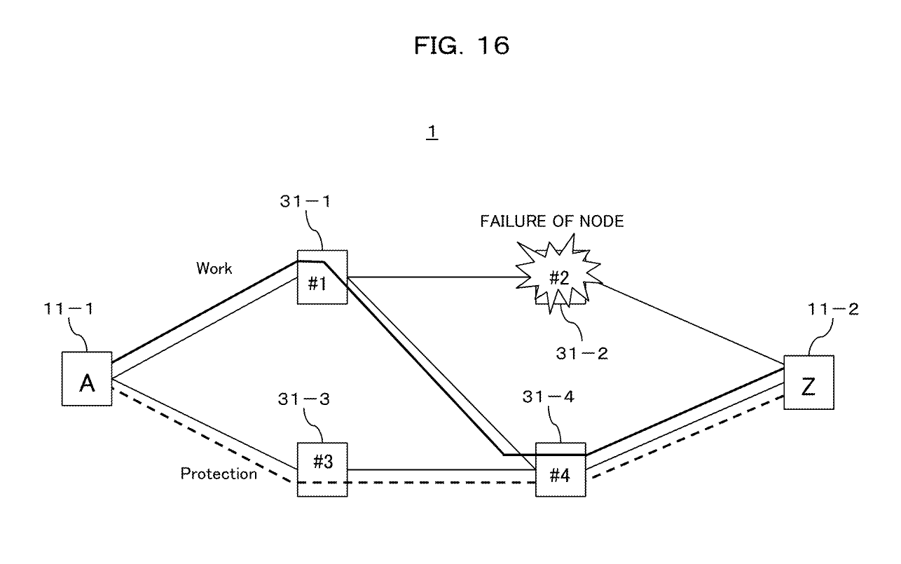

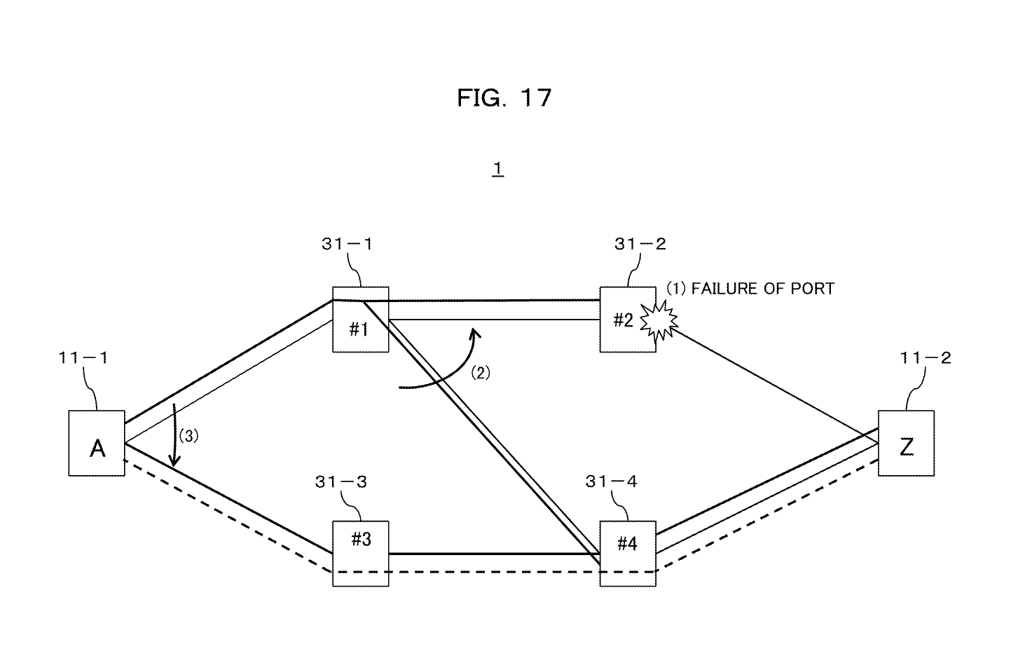

Next, with reference to FIGS. 16 and 17, an operation example when a node failure occurs in LSR#2 illustrated in FIG. 9 and then LSR#2 recovers from the node failure but a port failure in a port linked to the node Z from LSR#2 still occurs will be described.

As illustrated in FIG. 16, when a node failure occurs in LSR#2, like the example in FIG. 9, LSP#1 between LSRs#1 and #2 is switched to the bypass LSP between LSRs#1 and #4.

Therefore, as described with reference to FIG. 11, the node Z selects the protection system for which an assertion of SF is inhibited to receive user traffic transmitted to the work system by the node A and reached to the protection system via the bypass LSP between LSRs#1 and #4.

Thereafter, as illustrated in FIG. 17, it is assumed that LSR#2 recovers from the node failure but a port failure in a port linked to the node Z from LSR#2 still occurs (see (1) in FIG. 17).

With the recovery of LSR#2 from the node failure, the bypass LSP between LSRs#1 and #4 may be switched to LSP#1 between LSRs#1 and #2 (see (2) in FIG. 17).

In this case, the node Z fails to receive the CCM(w) transmitted to the work system by the node A due to the port failure of LSR#2 and an SF of the work system is detected due to a continuation of no reception of the CCM(w) for a predetermined time.

In response to switching from the bypass LSP to LSP#1, the node Z no longer receives the CCM(w) of the work system from the protection system. Alternatively, the node Z receives the CCM(p) and the APS (NR) signals transmitted to the protection system by the node A from the protection system.

Therefore, the node Z selects the protection system and transmits APS (SF) signals to the protection system.

Meanwhile, with focusing on the node A, the CCM(w) transmitted to the work system by the node Z does not reach the node A due to the port failure of LSR#2. Thus, the node A detects an SF of the work system due to a continuation of no reception of the CCM(w) of the work system for a predetermined time.

Meanwhile, the CCM(p) and the APS (SF) signals transmitted to the protection system by the node Z reach the node A, like during normal operation, via LSP#2 between LSRs#3 and #4 in response to switching from the bypass LSP to LSP#1.

Thus, since the node A is under a state where an SF of the protection system is not detected and an SF of the work system is detected, the node A selects the protection system from which an SF is not detected in response to a reception of the APS (SF) signal (see (3) in FIG. 17).

Accordingly, the nodes A and Z are available to properly continue the communications through the protection system. Therefore, it is possible to improve a reliability of the network 1.

(First Modification)

The above embodiment is an example of end-to-end “1:1 protection”, but is also available to support “1+1 protection”. For example, in the configuration of the node 11 illustrated in FIG. 12, a bridge connection (see solid line arrows and dotted line arrows) may be applied to the switch 113 such that signals are transmitted to both of the work and protection systems.

(Second Modification)

Also, the above embodiment is an example in which a path such as a VLAN path is set in a layer of the Ethernet 1 between the end-to-end nodes A and Z but an LSP of the MPLS may also be set to between the nodes A and Z.

In other words, the network 1 may be an MPLS network. In such a case, the other network 3 overlaid on the MPLS network 1 may be another MPLS network or an OTN (Optical Transport Network).

When the other MPLS network 3 is overlaid on the MPLS network 1, a hierarchical LSP can be set with a label stack in the other MPLS network 3.

When the OTN 3 is overlaid on the MPLS network 1, a signal (may also be referred to as a “client signal”) of the MPLS network 1 is mapped to an optical data unit (ODU) frame transmitted in the OTN 3.

(Third Modification)

In the above embodiment, a case when both of the end-to-end nodes A and Z support the operation illustrated in FIG. 11 is assumed. For example, it is assumed that both of the nodes A and Z have the configuration illustrated in FIG. 13 and the CCM/APS processor 42 of both of the nodes A and Z is set to enable.

However, there is a case where one of the nodes A and Z is not available to support the operation illustrated in FIG. 11. In such a case, the above APS operation would not success between the nodes A and Z.

Thus, the node 11 available for the operation illustrated in FIG. 11 may check whether the correspondent end node 11 is a node 11 available for the operation illustrated in FIG. 11. The checking may be done by transmitting and receiving APS signals between end nodes, for example.

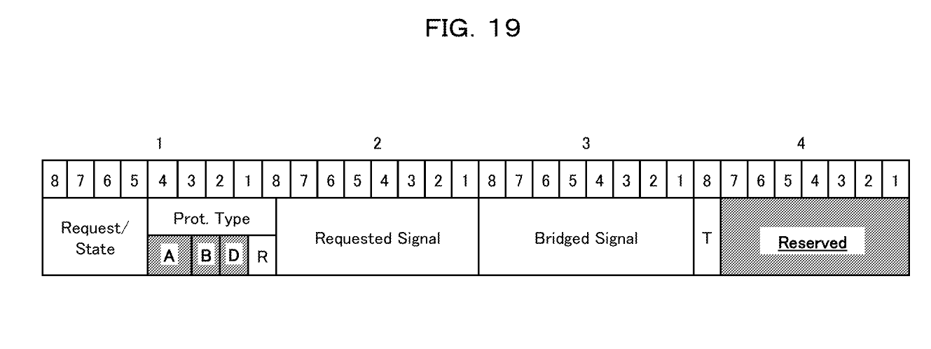

For example, the node 11 available for the operation illustrated in FIG. 11 sets information (for example, a flag) indicative of an availability of the operation to an APS signal to transmit the signal. The flag may be set to, for example, a reserved field of an APS signal format illustrated in FIG. 19. The flag may be set by the CCM/APS generator 421 (see FIG. 13).

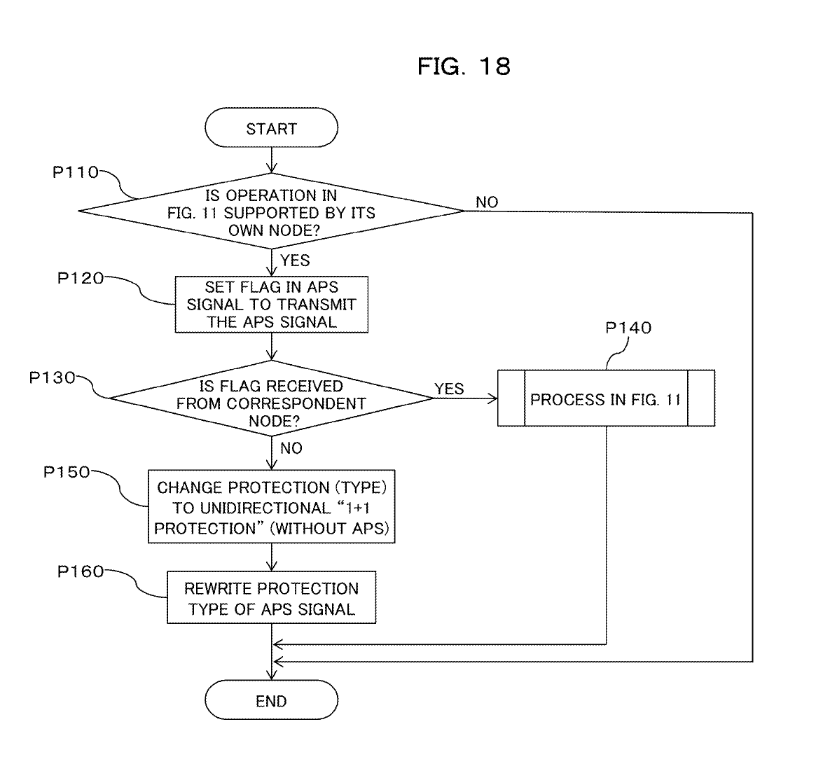

FIG. 18 illustrates an operation example of the node 11 (A or Z) according to the third modification. The flow chart illustrated in FIG. 18 may be performed by the controller 114 illustrated in FIGS. 12 and 13.

As illustrated in FIG. 18, when the node A (or Z) supports the operation in FIG. 11 (YES in Process P110), the node A (or Z) sets a flag to an APS signal and transmits the signal to the protection system (Process P120). When the node A (or Z) does not support the operation in FIG. 11 (NO in Process P110), the node A (or Z) may end the process.

The node A (or Z) checks whether to receive an APS signal by, for example, the CCM/APS receiver 422, which is transmitted to the protection system by the remote node Z (or A) of the end-to-end communications and to which a flag is set (Process P130).

When the node A (or Z) receives an APS signal to which the flag is set (YES in Process P130), the node A (or Z) may determine that the correspondent node Z (or A) supports the operation in FIG. 11. Therefore, the node A (or Z) may operate according to the flow chart in FIG. 11 (Process P140).

Meanwhile, when the node A (or Z) does not receive an APS signal to which the flag is set (NO in Process P130), the node A (or Z) may determine that the correspondent node Z (or TO does not support the operation in FIG. 11.

In this case, the node A (or Z) may determine that a mismatch of APS operation may occur with the correspondent node Z (or A). In response to the determination, the node A (or Z) may change the protection method to the unidirectional “1+1 protection” in which an APS signal is unused (Process P150). The change to the “1+1 protection” can be achieved by setting a bridge connection to the switch 113, as described above.

In response to the change of protection method, the node A (or Z) may rewrite protection type information in an APS signal transmitted to the protection system to information indicative of the changed unidirectional “1+1 protection (without APS signal)” (Process P160).

The protection type information may be rewritten by the CCM/APS generator 421. The protection type information may be indicated with bits represented by “Prot. type A, B, D” in the APS signal format illustrated in FIG. 19.

When the correspondent node Z (or A) receives an APS signal in which the protection type information is rewritten, the correspondent node Z (or A) can change the protection method of the local node Z (or A) to the unidirectional “1+1 protection (without APS signal)” according to the protection type information.

Accordingly, the unidirectional “1+1 protection (without APS signal)” operates for communications in both directions of the direction from the node A to the node Z and the opposite direction from the node Z to the node A.

The reception node Z for communication in the direction from the node A to the node Z and the reception node A for communication in the opposite direction are available to selectively receive user traffic of both of the work and protection systems by switching the switch 113 in response to a LOC detection, for example.

Even when one of the nodes A and Z does not support the operation illustrated in FIG. 11, as described above, it is possible to maintain a redundancy of communication paths on which user traffic is transmitted, by changing the protection method to “1+1 protection”.

According to the above technology, it is possible to improve a reliability of a network by inhibiting a mismatch of protection operations between end nodes.

All examples and conditional language provided herein are intended for pedagogical purposes to aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiment(s) of the present invention have been described in detail, it should be understood that the various changes, substitutions, alterations could be made hereto without departing from the spirit and scope of the invention.

What is claimed is:

1. A protection method comprising:
performing a switching control of work and protection communication paths set between end nodes in a first network, based on a reception state for each of signals transmitted to the communication paths;
performing a routing control for a partial section of the communication paths, the partial section belonging to a second network; and
controlling, in response to the routing control for the partial section in the second network, a detection process of a signal failure based on the reception state of the signal for the protection communication path.

2. The protection method according to claim 1, further comprising:
transmitting first signals to check continuity to the work and protection communication paths, respectively; and
transmitting a second signal for the switching control to the protection communication path, wherein
the control of the detection process of the signal failure includes
a process to inhibit a detection of the signal failure for the protection communication path in response to a reception of the first signal that is transmitted to the work communication path and is received from the protection communication path under a state where the second signal is not received from the protection communication path in one of the end nodes.

3. The protection method according to claim 2, wherein
the process to inhibit the detection of signal failure is performed in response to a confirmation that a transmission source of the first signal received from the protection communication path is the other end node that is registered.

4. A communication system comprising:
a first network configured to perform a switching control of work and protection communication paths set between end nodes, based on a reception state for each of signals transmitted to the work and protection communication paths;
a second network configured to perform a routing control for a partial section of the work and protection communication paths, the partial section belonging to the second network; and
a controller configured to control, in response to the routing control for the partial section in the second network, a detection process of a signal failure based on the reception state of the signal for the protection communication path.

5. The communication system according to claim 4, wherein
first signals to check continuity are transmitted to the work and protection communication paths, respectively,
a second signal for the switching control is transmitted to the protection communication path, and
the control of the detection process of the signal failure includes
a process to inhibit a detection of the signal failure for the protection communication path in response to a reception of the first signal that is transmitted to the work communication path and is received from the protection communication path under a state where the second signal is not received from the protection communication path in one of the end nodes.

6. The communication system according to claim 5, wherein
the process to inhibit the detection of signal failure is performed in response to a confirmation that a transmission source of the first signal received from the protection communication path is the other end node that is registered.

7. An end node of work and protection communication paths set in a first network, the end node comprising:
a first receiver configured to receive a signal from the work communication path;
a second receiver configured to receive a signal from the protection communication path; and
a controller configured to perform a switching control of the work and protection communication paths, based on a reception state of the signals in the first and second receivers, wherein
the controller controls a detection process of a signal failure for the protection communication path based on the reception state for the signals in the second receiver, in response to a routing control in a second network for a partial section of the work and protection communication paths, the partial section belonging to the second network.
